(19) United States
(12) Patent Application Publication
(10) Pub. No.: US 2026/0202019 A1
(43) Pub. Date: Jul. 16, 2026

(54) CRYOGENIC FLUID STORAGE UNIT AND CORRESPONDING PRODUCTION METHOD

(71) Applicant: Faurecia Hydrogen Solutions France, NANTERRE (FR)

(72) Inventors: Frédéric GREBER, ECOT (FR); Yannick FOURCAUDOT, LUZE (FR)

(21) Appl. No.: 19/137,364

(22) PCT Filed: Dec. 12, 2023
(86) PCT No.: PCT/EP2023/085375

§ 371 Date: Jun. 10, 2025

(30) Foreign Application Priority Data
Dec. 14, 2022 (FR) 22 13390

(51) Int. Cl. F17C 13/00

(52) U.S. Cl. CPC F17C 13/001; F17C 2203/014; F17C 2203/03; F17C 2223/0161

(57) ABSTRACT

A cryogenic fluid storage unit comprises
an internal tank,
an external tank (7), and
a proximal suspension (23P) connecting the proximal end (22D) of the internal tank to the external tank. The proximal suspension comprises an external tube rigidly attached to the proximal end of the internal tank, an internal tube arranged in the external tube and connected to the external tank, and a stopper connecting the internal tube to the external tube. The the proximal suspension comprises a proximal thermal insulation interposed radially between the external tube and the internal tube, the proximal thermal insulation comprising a thermally insulating sleeve and at least one blocking element having a central axis and resiliently biasing the sleeve against an internal surface of the external tube or against an external surface of the internal tube.

### CROSS-REFERENCE TO RELATED APPLICATIONS

This application is the US national phase of PCT/EP2023/085375, filed on Dec. 12, 2023 claiming the benefit of French Application No. 22 13390, filed on Dec. 14, 2022, which is incorporated herein by reference in its entirety.

### TECHNICAL FIELD

The disclosure relates in general to a cryogenic fluid storage unit.

### BACKGROUND

Such a storage unit typically comprises an internal tank, inwardly delimiting a receiving volume for the cryogenic fluid, and an external tank in which the internal tank is housed.

The storage unit further comprises a suspension, with a proximal suspension connecting a proximal end of the internal tank to the external tank, and a distal suspension connecting the distal end of the internal tank to the external tank.

It is possible to provide that the proximal suspension comprises an external tube rigidly attached to the proximal end of the internal tank, an internal tube arranged in the external tube and connected to the external tank, and a stopper connecting the internal tube to the external tube.

The external tube has a first end rigidly attached to the peripheral edge of an opening arranged in the proximal end of the internal tank. It extends inside the internal tank. It is in contact with the cryogenic fluid stored in the receiving volume. The stopper closes the second end of the external tube.

The internal tube has a first end exiting through the opening arranged at the proximal end of the internal tank, and a second end directly connected to the stopper. This second end is also closed by the stopper.

To limit radiative heat transfer between the external tank and the internal tank, a layer of an insulating material is placed over the internal tank, and completely enveloping it. To complete the thermal insulation, it is also necessary to reduce radiative transfer between the external tube and the internal tube of the proximal suspension. Installing thermal insulation between the two tubes is particularly tricky, as the space available for inserting this thermal insulation is extremely limited.

In this context, the disclosure aims to propose a cryogenic fluid storage unit in which the thermal insulation of the proximal suspension is particularly good.

### SUMMARY

To this end, the disclosure relates to a cryogenic fluid storage unit comprising:
an internal tank, internally delimiting a receiving volume for the cryogenic fluid, the internal tank having a proximal end and a distal end opposite the proximal end;
an external tank, in which the internal tank is housed;
a suspension, comprising a proximal suspension connecting the proximal end of the internal tank to the external tank, the proximal suspension including an external tube rigidly attached to the proximal end of the internal tank, an internal tube arranged in the external tube and connected to the external tank, and a stopper connecting the internal tube to the external tube;

the proximal suspension including a proximal thermal insulation interposed radially between the external tube and the internal tube, the proximal thermal insulation comprising a thermally insulating sleeve and at least one blocking element having a central axis and resiliently biasing the thermally insulating sleeve against an internal surface of the external tube or against an external surface of the internal tube.

The proximal thermal insulation interposed radially between the external tube and the internal tube limits radiative transfer between the external tube and the internal tube. This proximal thermal insulation is pressed against the external tube or against the internal tube by the blocking element.

It is thus held in place, with no chance of the thermally insulating sleeve forming a thermal bridge between the external tube and the internal tube.

The thermally insulating sleeve could constitute a thermal bridge if it were deformed and had a part touching the external tube and a part touching the internal tube. This issue is eliminated by the presence of the blocking tube.

The thermal insulation at the proximal suspension is thus improved.

The cryogenic fluid storage unit may further have one or more of the following features, considered individually or according to any technically possible combinations:
the blocking element has lugs at one axial end facing the stopper;
the blocking element has the form of a blocking tube with a specific external surface area, the blocking tube preferably being perforated in a proportion of between 50% and 99% of its external surface area;
the blocking tube has a slot delimited by two opposite axial edges, the slot extending over an entire axial length of the blocking tube, the blocking tube including fasteners capable of being selectively locked or released, the two axial edges of the blocking tube being free with respect to one another when the fasteners are released and being attached to one another when the fasteners are locked;
the external tube has an internal diameter, the thermally insulating sleeve has a sleeve thickness, the blocking tube has, at rest, when the fasteners are released, a rest diameter, the rest diameter of the blocking tube plus twice the sleeve thickness being greater than the internal diameter of the external tube;
when the fasteners are locked, the blocking tube has a reduced diameter greater than the external diameter of the internal tube, the reduced diameter of the blocking tube plus twice the sleeve thickness being less than the internal diameter of the external tube;
the blocking element is pressed against a radially internal surface of the thermally insulating sleeve, a protective tube being pressed against a radially external surface of the thermally insulating sleeve;
the thermally insulating sleeve is out of contact with the internal tube and/or with the stopper.

According to a second aspect, the disclosure relates to a method for producing a storage unit having the features hereinbefore, the method comprising the following steps:
obtaining the internal tank, the internal tube, the external tube, the stopper, and the blocking tube;
assembling the internal tank, the internal tube, the external tube and the stopper to each other;
fitting the thermally insulating sleeve around the blocking tube;
locking the fasteners;
inserting the thermally insulating sleeve and the blocking tube between the internal tube and the external tube;
releasing the fasteners.

The production method may further have the following features:
in the step of fitting the sleeve around the blocking tube, the blocking tube is constrained to an intermediate diameter equal to the internal diameter of the external tube plus twice the sleeve thickness, plus or minus 10%.

### BRIEF DESCRIPTION OF THE DRAWINGS

Other features and advantages of the disclosure will become apparent from the detailed description given hereunder, by way of non-limiting indication, referring to the appended figures, among which:

FIG. 1 is an axial sectional view of the cryogenic fluid storage unit;

FIG. 2 is an enlarged sectional view of the suspension of the proximal end of the internal tank of FIG. 1; and

FIG. 3 is a perspective view of the blocking tube of the thermal insulation of the suspension of FIG. 2.

### DETAILED DESCRIPTION

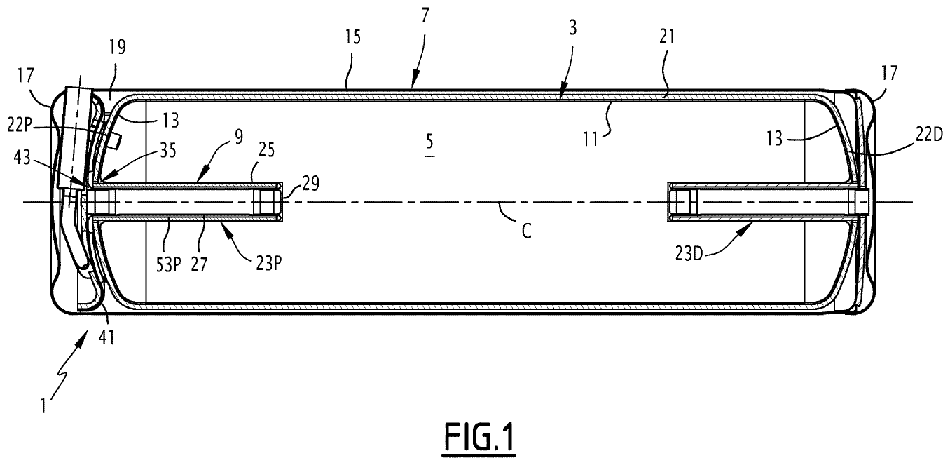

The storage unit 1 shown in FIG. 1 is intended to store a cryogenic fluid. Cryogenic fluid is understood to mean a fluid at a very low temperature, which may be at least partially in the liquid state inside the storage unit.

This fluid is typically hydrogen. Alternatively, the fluid is helium, nitrogen, natural gas such as methane CH₄, air or any other suitable fluid.

This storage unit is typically intended to be installed on board a vehicle having an electric propulsion motor, for example a motor vehicle, a train, a boat or any other vehicle.

The motor vehicle is, for example, a car, a utility vehicle, a truck, etc.

The storage unit 1 is typically designed to power a fuel cell. The fuel cell is configured to produce electricity and to supply the electric propulsion motor of the vehicle.

The storage unit 1 comprises an internal tank 3, inwardly delimiting a reception volume 5 for the cryogenic fluid, an external tank 7 in which the internal tank 3 is housed, and a suspension 9.

The suspension 9 is intended to attach the internal tank 3 to the external tank 7.

In the example shown, the internal reservoir 3 has a horizontal central axis C.

It includes a shell 11, closed at both axial ends by bottoms 13.

The shell 11 is cylindrical, centered on the central axis C.

The external reservoir 7 also has a horizontal axis.

It includes a shell 15 surrounding the shell 11 of the internal tank, closed at both ends by bottoms 17 placed opposite the bottoms 13 of the internal tank 3.

The shell 15 is cylindrical, centered on the central axis C.

The internal tank 3 and the external tank 7 delimit an intermediate space 19 therebetween, kept under a high vacuum. This vacuum is typically of the order of 10-5 millibar, so as to strongly limit heat transfer by convection from the external tank 7 to the internal tank 3.

Thermal insulation 21 is interposed between the internal reservoir 3 and the external reservoir 7. The thermal insulation 21 is typically placed on the external surface of the internal reservoir 3.

The thermal insulation 21 for example includes a plurality of metal sheets superimposed on one another, with interposition of fiber layers.

The suspension 9 is arranged so that the entire weight of the internal reservoir 3 is taken up by the external reservoir 7 via the suspension 9.

The weight of the internal tank 3 is understood here to include the weight of the cryogenic fluid stored in the internal tank 3.

The accelerations undergone by the internal tank 3 and the cryogenic fluid contained in the internal tank 3 are also transmitted to the external tank 7 via the suspension 9.

When the storage unit 1 is installed in a vehicle, these accelerations result from changes in vehicle direction, braking applied to the vehicle, acceleration of the vehicle, asperities or irregularities in the road, or even impacts to the vehicle.

The internal tank 3 has a proximal end 22P, and a distal end 22D opposite the proximal end 22P.

In the example shown, the proximal and distal ends correspond to the two bottoms 13 of the internal tank 3.

The suspension 9 comprises a proximal suspension 23P connecting the proximal end 22P of the internal tank 3 to the external tank 7.

Similarly, the suspension 9 comprises a distal suspension 23D connecting the distal end 22D of the internal tank 3 to the external tank 7.

Typically, the proximal suspension 23P and the distal suspension 23D are identical to each other. Only the proximal suspension 23P will be described below

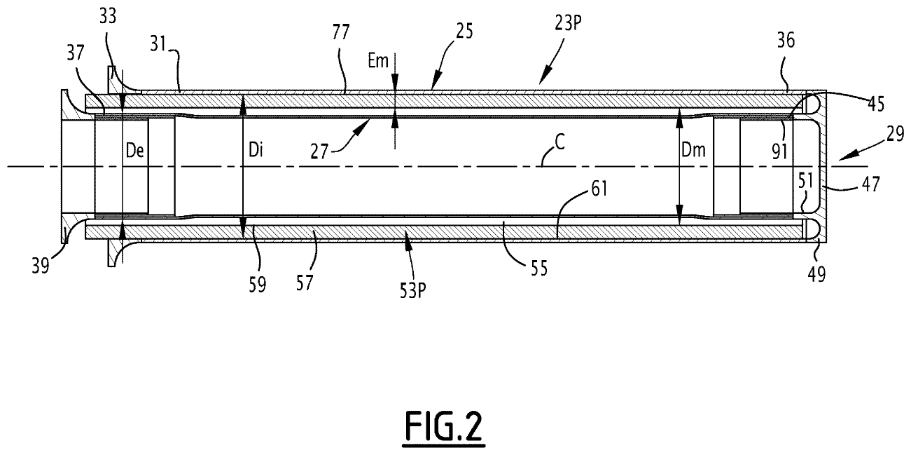

The proximal suspension 23P, as seen in FIG. 2, includes an external tube 25 rigidly attached to the proximal end 22P of the internal tank 3, an internal tube 27 arranged in the external tube 25 and connected to the external tank 7, and a stopper 29 connecting the internal tube 27 to the external tube 25.

The external tube 25 is typically coaxial with the central axis C.

It has a first end 31 rigidly attached to a ring 33, itself integral with the edge of an opening 35 arranged at the proximal end 22P of the internal tank 3.

The external tube 25 has a second end 36, opposite the first end 31, rigidly attached to the stopper 29.

The external tube 25, perpendicular to the central axis C, is typically circular in cross-section.

It has a substantially constant cross-section over its entire axial length.

The external tube 25 extends from the proximal end 22P inwardly into the internal tank 3. The stopper 29 is therefore also located inside the internal tank 3.

The internal tube 27 is coaxial with the central axis C.

It has a first end 37 rigidly attached to a ring 39. The ring 39 is connected to the external tank 7 via the cup 41. The ring 39 is rigidly attached to the edge of an opening 43 arranged in the cup 41.

The internal tube 27 has a second end 45, rigidly attached to the stopper 29.

The stopper 29 seals both the external tube 25 and the internal tube 27. It includes a solid bottom 47, bearing two concentric annular ribs 49, 51.

The external tube 25 is rigidly attached to the radially external rib 49.

The internal tube 27 is rigidly attached to the radially internal rib 51.

As can be seen in FIG. 2, the proximal suspension 23P comprises a proximal thermal insulation 53P interposed radially between the external tube 25 and the internal tube 27.

The proximal thermal insulation 53P is slid into the cylindrical gap 55 between the external tube 25 and the internal tube 27.

The proximal thermal insulation 53P comprises a thermally insulating sleeve 57 and a blocking element 59.

The blocking element 59 resiliently biases the sleeve 57 against an internal surface 61 of the external tube 25.

The sleeve 57 is tubular, coaxial with the central axis C.

It is constructed in substantially the same way as the thermal insulation 21 fitted on the internal tank 3.

It thus comprises a plurality of metal sheets radially superimposed on one another, with interposition of fiber layers.

The metal layers are substantially cylindrical, coaxial with the central axis C, and stacked radially on top of each other, with interposition of fiber layers.

Alternatively, the sleeve 57 is obtained by layering a fiber layer on a metal sheet, and by winding the metal sheet and the fiber layer together in a spiral around a mandrel. It is possible to wind the metal layer and the fiber layer from a single roll, or a roll of metal sheet and a roll of fiber layer can be unwound in parallel.

The metal layers are made of aluminum or an aluminum alloy. Each layer is particularly thin, and has a thickness of around 7 μm.

The fibers in the fiber layer are for example glass fibers. They come in the form of a paper-like material.

The total number of radially stacked metal layers and fiber layers is typically between 10 and 40.

The blocking element 59 is preferably a blocking tube.

The blocking element 59 is typically coaxial with the central axis C. It is pressed against a radially internal surface of the sleeve 57.

The blocking element 59 has, perpendicular to its central axis C, a substantially circular cross-section, which is constant over its entire length.

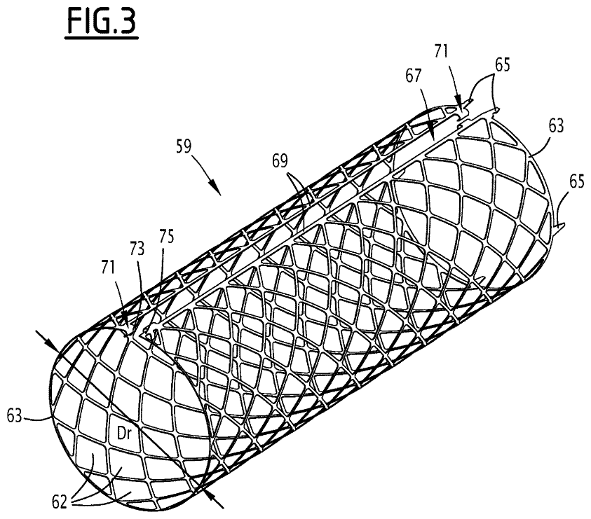

The blocking element 59 is shown in greater detail in FIG. 3. The blocking element 59 is made of a metal, preferably a metal having low or moderate thermal conductivity.

For example, the blocking element 59 is made of stainless steel so as to prevent corrosion.

For example, it is made of 316L stainless steel.

The blocking tube 59 is perforated so as to limit heat transfer by conduction therein.

It has a specific external surface area, and is perforated in a proportion of between 50 and 99% of its external surface area. The blocking element 59 is preferably perforated in a proportion of between 60% and 95%, even more preferably between 70% and 90% of its external surface area.

The external surface area is the surface area of the radially external surface of the blocking element 59.

As seen in FIG. 3, the wall of the blocking element 59 has a large number of openings 62. The cumulative surface area of the openings 62 is between 50% and 99% of the external surface area of the blocking tube 59.

In the example shown, the openings 62 are substantially diamond-shaped. Alternatively, they are rectangular, circular, or have any other suitable shape.

The blocking element 59 is delimited at both axial ends thereof by substantially circular edges 63.

It has lugs 65 at its axial end facing the stopper 29. The lugs 65 point axially from the circular edge 63.

They point towards the stopper 29.

The sleeve 57 extends all the way around the blocking element 59. In other words, it covers the entire radially external surface of the blocking element 59. Axially, it extends from one circular edge 63 to the other. Typically, the sleeve 57 does not project axially beyond the circular edges 63 of the blocking element 59.

Thus, the lugs 65 also project axially with respect to the sleeve 57.

The lugs 65 therefore prevent any contact between the sleeve 57 and the stopper 29.

This is particularly advantageous as the sleeve 57 is anisotropic. It has particularly low thermal conductivity in the radial direction. This conductivity is of the order of 0.02 mW/m·K.

On the other hand, its axial thermal conductivity is much higher. This axial conductivity is of the order of 6000 mW/m·K. This is because aluminum foil has a particularly high thermal conductivity.

It is therefore vital to avoid any axial contact between the sleeve 57 and the stopper 29, as the stopper 29 is in direct contact with the cryogenic fluid filling the internal tank 3.

As seen in FIG. 3, the blocking element 59 has a slot 67 delimited by two opposite axial edges 69.

The slot 67 extends along the entire axial length of the blocking element 59. It is open at the two circular edges 63 of the blocking tube 59.

The blocking element 59 further comprises fasteners 71 that can be selectively locked or released.

When the fasteners 71 are released, the two axial edges 69 of the blocking element 59 are free from each other.

They are spaced apart, as shown in FIG. 3.

On the contrary, when the fasteners 71 are locked, the two axial edges 69 of the blocking element 59 are attached to each other.

Typically, they then extend in close proximity to each other, or even against each other.

Thus, when the fasteners 71 are locked, the blocking tube 59 is not susceptible to radial expansion.

On the contrary, when the fasteners 71 are released, the blocking tube 59 is likely to expand radially.

The fasteners 71 comprise, in the example shown, hooks 73 carried by one of the axial edges 69 of the blocking element 59, and tongues 75 arranged in the other axial edge 69 of the blocking element 59. In the locked position, the hook 73 is engaged with the tongue 75. In the released position, the hook 73 is not engaged with the tongue 75.

Alternatively, the fastener 71 can be of any other type, and include for example two hooks 73 carried by the two opposite axial edges 69 of the blocking element 59, and an axis which can be engaged in the hooks 73 and extracted therefrom.

When the fasteners 71 are released, the blocking element 59 has a rest diameter Dr at rest. “At rest” herein means in the absence of external constraint.

When the fasteners 71 are released, the blocking element 59 is radially elastic.

In other words, if it is forced by an external force to a diameter less than its rest diameter Dr, it resists an elastic restoring force in the direction of radial expansion. If the external force is removed, it elastically returns to its rest diameter Dr.

The rest diameter Dr of the blocking element 59 plus twice the thickness of the sleeve Em is greater than or equal to the internal diameter Di of the external tube 25. In other words:

$$Dr + 2 Em \geq Di$$

This means that, when the fasteners 71 are released, the blocking element 59 will spontaneously press the sleeve 57 against the internal surface of the external tube 25, due to the choice of its rest diameter Dr.

According to another aspect, when the fasteners 71 are locked, the blocking element 59 has a reduced diameter Dd greater than the external diameter De of the internal tube 27. The maximum external diameter of the internal tube 57 is considered herein. In the example shown, the external diameter is at its maximum at both ends of the internal tube 27.

Furthermore, the reduced diameter Dd of the blocking element 59 plus twice the sleeve thickness Em is less than or equal to the internal diameter Di of the external tube 25. In other words:

$$Dd > De and Dd + 2 Em \leq Di$$

These conditions reflect the fact that the proximal thermal insulation 53P can be slid axially into the gap 55 between the internal tube 27 and the external tube 25 when the fasteners 71 are locked.

The diameter of the blocking element 59 in this situation remains greater than the external diameter De of the internal tube 27. On the other hand, the reduced diameter Dd is selected to be small enough so that the proximal thermal insulation 53P does not interfere with the external tube 25 when it is inserted into the gap 55.

To facilitate the insertion of the proximal thermal insulation 53P axially into the gap 55, a protective tube 77 is pressed against a radially external surface of the sleeve 53.

The protective tube 77 is made of polytetrafluoroethylene (PTFE, or is a metal tube. It can be perforated if the tube 77 remains in place after insertion.

It has a low coefficient of friction against the material making up the external tube 25.

It is thin and is made of a low-rigidity material, so as not to interfere with the expansion of the blocking element 59 and the elastic pressing of the sleeve 57 against the internal surface of the external tube 25.

The protective tube 77 protects the sleeve 57 and prevents any damage thereof during insertion into the gap 55.

As shown hereinbefore, the sleeve 57 is made up of particularly thin metal sheets and layers of fibers, which also have a very low mechanical strength. Thus, any physical contact between the sleeve 57 and the external tube 25 can cause the external layers of the sleeve 57 to tear, and lead to the creation of bumps on the external surface of the sleeve 57.

As seen in FIG. 2, after insertion into the gap 55, the sleeve 57 is out of contact with the internal tube 27, and out of contact with the stopper 29.

An example embodiment will now be briefly described.

The external diameter De of the internal tube 27 is approximately 114.3 millimeters. The internal diameter Di of the external tube 25 is approximately 149.2 millimeters.

The sleeve 57 has a thickness Em of approximately 10 millimeters.

The blocking element 59 is a type 316L stainless steel blank, approximately 0.5 millimeters thick. This blank is made of wire mesh. It is cut by stamping or die-cut.

The blank is then rolled and assumes its rest diameter. The rest diameter Dr is approximately 133 millimeters.

The width of the slot 67, at rest, is approximately 15 millimeters.

The reduced diameter Dd of the blocking element 59 is approximately 118 millimeters.

The method of producing the storage unit 1 hereinbefore will now be described.

The method comprises a step of obtaining the internal tank 3, the internal tube 27, the external tube 25, the stopper 29, and the blocking element 59.

The blocking element 59 is obtained as described previously, from a blank of a wire mesh. The blank is then rolled to give it a cylindrical shape.

The method also includes a step of assembling the internal tank 3, the internal tube 27, the external tube 25 and the stopper 29 to each other.

The method then comprises a step of fitting the sleeve 57 around the blocking element 59. It then includes the following steps:
Locking the fasteners 71;
Inserting the sleeve 57 and the blocking element 59 between the internal tube 27 and the external tube 25;
Releasing the fasteners 71.

In the fitting step, the blocking element 59 is advantageously constrained to an intermediate diameter Dm equal to the internal diameter Di of the external tube 25 plus twice the sleeve thickness Em, plus or minus 10%.

To do this, the blocking element 59 is mounted on a mandrel and pressed against this mandrel. The mandrel has said intermediate diameter Dm. The sleeve 57 is then positioned around the blocking element 59, constrained to the intermediate diameter Dm. It is wound or formed or threaded around the blocking element 59.

In other words, at the fitting step, the sleeve 57 and the blocking element 59 substantially have the final diameter that they will occupy once arranged inside the external tube 25, against the internal surface thereof.

The sleeve 57 and the blocking element 59 are inserted axially, through the ring 33 and the first end 31 of the external tube 25.

The fasteners 71 are then released by slightly deforming the blocking element 59, so as to disengage the hooks 73 from the lugs 75.

Once the fasteners have been released, the blocking element 59 expands elastically in diameter, until it returns substantially to the intermediate diameter Dm.

The storage unit disclosed hereinbefore has multiple advantages.

Designing the blocking element in the form of a tube makes it easy to fit onto the sleeve and ensures that the sleeve is held securely.

Since between 50% and 99% of the external surface area of the blocking element is perforated, conductive heat transfer in the blocking element is extremely low.

The fact that the blocking element has lugs at one axial end facing the stopper prevents contact between the sleeve and the stopper. This is particularly important to limit heat transfer in the axial direction through the metal layers making up the sleeve.

The fact that the blocking element has a slot running its entire length and fasteners capable of interlocking the two axial edges delimiting the slot enables the diameter of the blocking element, and therefore of the proximal thermal insulation, to be temporarily reduced. This makes it easier to insert the proximal thermal insulation axially into the gap between the internal tube and the external tube. Once the proximal thermal insulation is axially in place, the fasteners can be released, allowing the blocking element to expand radially elastically and press the sleeve against the internal surface of the external tube. This is performed in a particularly convenient manner.

The chance of interference between the sleeve and the external tube are reduced, as are the chances of damage to the upper layers of the sleeve.

The fact that the blocking element has at rest, when the fasteners are released, a rest diameter selected so that this rest diameter plus twice the thickness of the sleeve is greater than the internal diameter, allows the sleeve to be elastically pressed against the internal surface of the external tube.

The fact that the blocking element has, when the fasteners are locked, a reduced diameter greater than the external diameter of the internal tube, the reduced diameter plus twice the sleeve thickness being less than the internal diameter of the external tube, allows the proximal thermal insulation to be inserted axially between the internal tube and the external tube, with reduced chances of interference from the proximal thermal insulation with the external tube or the internal tube.

The fact that the blocking element is pressed against a radially internal surface of the sleeve and that a protective tube is pressed against a radially external surface of the sleeve makes it possible to protect the radially external surface of the sleeve during insertion between the internal tube and the external tube.

The fact that the sleeve is out of contact with the internal tube without being in contact with the stopper limits heat transfer.

The fact that the sleeve is not free in the space between the internal face of the external tube and the external face of the internal tube ensures that it will not move throughout the use of the tank, notably that its end can touch the stopper. If the metal part of the multi-layer insulation were to touch this stopper, the performance of the insulation would be severely affected.

The storage unit and the production method can take many forms.

The example described hereinbefore comprises a sleeve that is elastically pressed against the internal surface of the external tube by the blocking element. In one variant, this sleeve is placed on the external surface of the internal tube, and is resiliently biased against it by the blocking element. Thus, the sleeve can be pressed against the external face of the internal tube of the suspension, with the blocking element attaching the multi-layer insulation on the other side. In this case, the blocking element has a smaller free diameter and is open to allow insertion. This variant is particularly advantageous because the external tube of the suspension is at a very low temperature, so its radiation is therefore very low. However, the internal tube of the suspension is hotter and therefore radiates much more. It is therefore very useful to limit this radiation very quickly by placing multi-layer insulation on this hot component. The last layer of insulation is at a much lower temperature than that of the external surface of the internal tube of the suspension. This lower temperature limits the radiation from this last layer towards the internal surface of the external tube of the suspension. The amount of heat radiated depends on the temperature to the fourth power.

In this case, the blocking element is arranged on the radially external surface of the sleeve.

Typically, the distal suspension includes distal thermal insulation identical to the proximal thermal insulation. Alternatively, the distal thermal insulation is different.

The blocking element may not be a tube, but may include, for example, several rings distributed along the sleeve.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content

1. A cryogenic fluid storage unit comprising:
an internal tank, internally delimiting a volume for receiving cryogenic fluid, the internal tank having a proximal end and a distal end opposite the proximal end;
an external tank, in which the internal tank is housed;
a suspension, including a proximal suspension connecting the proximal end of the internal tank to the external tank, the proximal suspension including an external tube rigidly attached to the proximal end of the internal tank, an internal tube arranged in the external tube and connected to the external tank, and a stopper connecting the internal tube to the external tube; and
the proximal suspension including a proximal thermal insulation interposed radially between the external tube and the internal tube, the proximal thermal insulation comprising a thermally insulating sleeve and at least one blocking element having a central axis and resiliently biasing the thermally insulating sleeve against an internal surface of the external tube or against an external surface of the internal tube.

2. The cryogenic fluid storage unit according to claim 1, wherein the at least one blocking element has lugs at an axial end facing the stopper.

3. The cryogenic fluid storage unit according to claim 1, wherein the at least one blocking element is in a form of a blocking tube with a specific external surface area.

4. The cryogenic fluid storage unit according to claim 3, wherein the blocking tube has a slot delimited by two opposite axial edges, the slot extending over an entire axial length of the blocking tube, the blocking tube including fasteners which can be selectively locked or released, the two opposite axial edges of the blocking tube being free of each other when the fasteners are released and being attached to each other when the fasteners are locked.

5. The cryogenic fluid storage unit according to claim 4, wherein the external tube has an internal diameter, the thermally insulating sleeve has a sleeve thickness, the blocking tube has a rest diameter at rest when the fasteners are released, the rest diameter of the blocking tube plus twice the sleeve thickness being greater than the internal diameter of the external tube.

6. The cryogenic fluid storage unit according to claim 5, wherein the blocking tube has, when the fasteners are locked, a reduced diameter greater than an external diameter of the internal tube, the reduced diameter of the blocking tube plus twice the sleeve thickness being less than the internal diameter of the external tube.

7. The cryogenic fluid storage unit according to claim 1, wherein the at least one blocking element is pressed against a radially internal surface of the thermally insulating sleeve, a protective tube being pressed against a radially external surface of the thermally insulating sleeve.

8. The cryogenic fluid storage unit according to claim 1, wherein the thermally insulating sleeve is out of contact with the internal tube and/or with the stopper.

9. A method for producing a storage unit according to claim 4, the method comprising:
obtaining the internal tank, the internal tube, the external tube, the stopper and the blocking tube;
assembling the internal tank, the internal tube, the external tube and the stopper to each other;
fitting the thermally insulating sleeve around the blocking tube;
locking the fasteners;
inserting the thermally insulating sleeve and the blocking tube between the internal tube and the external tube; and
releasing the fasteners.

10. The method according to claim 9, wherein in the step of fitting the thermally insulating sleeve around the blocking tube, the blocking tube is constrained to an intermediate diameter equal to an internal diameter of the external tube plus twice a sleeve thickness, plus or minus 10%.

11. The cryogenic fluid storage unit according to claim 3, wherein the blocking tube is perforated in a proportion of between 50% and 99% of its external surface area.
